(19) United States
(12) Patent Application Publication
(10) Pub. No.: US 2022/0403293 A1
(43) Pub. Date: Dec. 22, 2022

(54) POLYMER DISPERSION AND A FABRIC CONDITIONING COMPOSITION COMPRISING THE SAME

(71) Applicant: RHODIA OPERATIONS, Lyon (FR)

(72) Inventors: David James Wilson, Coye-La-Forêt (FR); Pierre-Emmanuel Dufils, Paris (FR); Jean-Christophe Castaing, Sèvres (FR); Konstantin Nikolaev Golemanov, Aubervilliers (FR); Ritu Ahuja, Singapore (SG); Zahrah Mohamed Ikhbar, Singapore (SG); Shu Quan Chua, Singapore (SG); Siu Yu Chan, Singapore (SG); Boh Yi Lian, Singapore (SG)

(73) Assignee: RHODIA OPERATIONS, Lyon (FR)

(21) Appl. No.: 17/765,930

(22) PCT Filed: Sep. 23, 2020
(86) PCT No.: PCT/EP2020/076625

§ 371 Date: Apr. 1, 2022

(30) Foreign Application Priority Data
Oct. 3, 2019 (EP) 19306271.8

(51) Int. Cl. C11D 3/00; C11D 3/37

(52) U.S. Cl. CPC C11D 3/001; C11D 3/3773

(57) ABSTRACT

The present invention relates to a novel polymer dispersion and the application in conditioning fabrics. The present invention is further a fabric conditioning composition comprising the same. The fabric conditioning composition provided in the present invention has favorable fabric conditioning performance.

### FIELD OF THE INVENTION

The present invention relates to a novel polymer dispersion and the use thereof in conditioning fabrics. The present invention is further a fabric conditioning composition comprising the same. The fabric conditioning composition provided in the present invention has favorable fabric conditioning performance.

### BACKGROUND OF THE INVENTION

Polymerization-induced Self-Assembly (PISA) is a process which allows the formation of molecular assemblies of amphiphilic polymers. The amphiphilic polymer molecule consists of hydrophilic and hydrophobic polymer blocks. Initially the hydrophilic block is produced in water via a reversible deactivation radical polymerization process such as macromolecular design by the Interchange of Xanthates (MADIX). The MADIX process allows production of polymer chains with well-defined molecular weight and narrow distribution by weight. As a next step the hydrophobic monomer is linked to the hydrophilic chain and the hydrophobic block is grown, again via MADIX polymerization, until the hydrophobic block becomes insoluble in water. This induces the self-assembly of the amphiphilic block copolymers to create particles where the polymerization will subsequently happen. The final product of the polymerization process is a dispersion of polymer particles (latex).

Fabric conditioning compositions can be added in the rinse cycle of the laundering process to soften fabrics and to impart them nice smell. Conventionally, fabric conditioning systems are based on quaternary ammonium compounds, also named as quats, notably cetrimonium chloride, behentrimonium chloride, N,N-bis(stearoyl-oxy-ethyl) N,N-dimethyl ammonium chloride, N,N bis(tallowoyl-oxy-ethyl) N,N-dimethyl ammonium chloride, N,N bis(stearoyl-oxy-ethyl) N-(2-hydroxyethyl) N-methyl ammonium methylsulfate or 1,2-di(stearoyl-oxy)-3-trimethyl ammoniumpropane chloride.

Ester quats are widely used as fabric softeners owing to their good conditioning performance and biodegradability. However a problem associated with the ester quats is that the stability of such compounds is not satisfactory, particularly when the ester quats are present at high levels in the fabric conditioning composition, which may be attributed to its biodegradable nature. Thus, there is a need to provide a composition which provides good stability and excellent conditioning performance.

Silicone oil can work together with ester quats to further improve conditioning performance, however silicone oil is more expensive and not considered environmental friendly as take long to degrade in environment, therefore personal care products is trying to look for new materials to replace silicone oil.

### SUMMARY OF INVENTION

In one aspect of the present invention is to provide a polymer dispersion, wherein the polymer dispersion is prepared by a step (E) of radical polymerization in an aqueous medium (M) in the presence of:
at least a pre-polymer (p0) soluble in the medium (M) of formula (I):

(R¹¹)x-Z¹¹—C(═S)—Z¹²-[A]-R¹² (I)
wherein:
Z¹¹ represents C, N, O, S or P,
Z¹² represents S or P,
R¹¹ and R¹², which may be identical or different, represent:
   an optionally substituted alkyl, acyl, aryl, alkene or alkyne group (i), or
   a saturated or unsaturated, optionally substituted or aromatic carbon-based ring (ii), or
   a saturated or unsaturated, optionally substituted heterocycle (iii), these groups and rings (i), (ii) and (iii) possibly being substituted with substituted phenyl groups, substituted aromatic groups or groups: alkoxycarbonyl or aryloxycarbonyl (—COOR), carboxyl (—COOH), acyloxy (—O₂CR), carbamoyl (—CONR), cyano (—CN), alkylcarbonyl, alkylarylcarbonyl, arylcarbonyl, arylalkylcarbonyl, phthalimido, maleimido, succinimido, amidino, guanidimo, hydroxyl (—OH), amino (—NR), halogen, allyl, epoxy, alkoxy (—OR), S-alkyl, S-aryl, groups of hydrophilic or ionic nature such as the alkali metal salts of carboxylic acids, the alkali metal salts of sulphonic acid, polyalkylene oxide (PEO or PPO) chains and cationic substituents (quaternary ammonium salts), R representing an alkyl or aryl group;
x corresponds to the valency of Z¹¹, or alternatively x is 0, in which case Z¹¹ represents a phenyl, alkene or alkyne radical, optionally substituted with an optionally substituted alkyl; acyl; aryl; alkene or alkyne group; an optionally substituted, saturated, unsaturated, or aromatic, carbon-based ring; an optionally substituted, saturated or unsaturated heterocycle; alkoxycarbonyl or aryloxycarbonyl (—COOR); carboxyl (COOH); acyloxy (—O₂CR); carbamoyl (—CONR); cyano (—CN); alkylcarbonyl; alkylarylcarbonyl; arylcarbonyl; arylalkylcarbonyl; phthalimido; maleimido; succinimido; amidino; guanidimo; hydroxyl (—OH); amino (—NR); halogen; allyl; epoxy; alkoxy (—OR), S-alkyl; S-aryl groups; groups of hydrophilic or ionic nature such as the alkali metal salts of carboxylic acids, the alkali metal salts of sulphonic acid, polyalkylene oxide (PEO or PPO) chains and cationic substituents (quaternary ammonium salts); and
[A] represents a polymer chain, wherein the polymer chain derives from monomers comprising non-ionic monomers [An;
at least one free-radical polymerization initiator, and
at least one ethylenically unsaturated hydrophobic monomer (m) which is the one or more selected from the group consisting of C₁-C₁₀ alkyl (meth)acrylate and C₁-C₁₀ alkenyl (meth)acrylate;
wherein the aqueous medium (M) includes water and at least one water miscible solvent.

It was surprisingly found that the polymer dispersion of the present invention has special advantages in fabric conditioning applications over the conventional quaternary ammonium compounds.

In another aspect of the present invention is to provide a fabric conditioning composition comprising the polymer dispersion.

In one embodiment of the present invention, the fabric conditioning composition further comprises ester quaternary ammonium salts, particularly further comprising polysaccharide, the fabric conditioning composition has parity conditioning performance as those comprising quaternary ammonium conditioners and silicone.

The fabric conditioning composition of the present invention has favorable conditioning and fragrance performance.

Another aspect of the present invention is to provide a use of the polymer dispersion in conditioning fabrics.

Yet Another aspect of the present invention is to provide a method of conditioning a fabric, comprising the steps of contacting the fabric with an aqueous medium comprising the fabric conditioning composition as described above.

### DETAILED DESCRIPTION OF INVENTION

I. Polymer Dispersion

1. Step E of Radical Polymerization

One aspect of the present application is to provide a polymer dispersion, wherein the polymer dispersion is prepared by a step (E) of reversible deactivation radical polymerization in an aqueous medium (M). Throughout the context of the present application, reversible deactivation radical polymerization has the same meaning as “controlled radical polymerization.

The step (E) may be typically performed in batch or semi-batch. The step (E) is generally implemented without any surfactant in addition to the pre-polymer (p0) and the monomers (m) and initiator(s). Amphiphilic block copolymers thereby form and self-assemble into self-stabilized dispersions within the course of the polymerization by polymerization-induced self-assembly (PISA).

In some specific cases, the use of surfactants may be contemplated in step (E) (even if not compulsory, it may be of interest in some cases, to add surfactant in addition to the pre-polymer (p0) and the monomers (m), depending on the final application intended for the dispersion). The surfactants may be chosen from, but not limited to, ionic, non-ionic and amphoteric surfactants, such as polyvinyl alcohols, fatty alcohols or alkylphenol sulfates or sulfonates, alkylbenzene sulfonates, for example dodecylbenzene sulfonate, sulfosuccinates, quaternary ammonium salts or ethylated fatty alcohol.

In the case that additional surfactants are used in step (E), it is preferably present in low concentration. Typically, from 0.1 to 10% of surfactant may be used, preferably, from 0.5 to 8, and advantageously from 1 to 5% by weight based on the total weight of the dispersion.

In the scope of the invention, the PISA process is performed in a specific hydrophilic medium, comprising water and a water miscible solvent. It is believed that such solvent does not affect the mechanism implied by the PISA process.

The process as defined above affords polymer dispersions with relatively low viscosity, high polymer content (typically more than 30% by weight based on the total weight of the dispersion) in a specific medium.

The polymer dispersions of the present invention can be typically used as fabric conditioners dispersed in aqueous medium.

2. The Polymer Chain [A]

The polymer chain [A] is selected in order to impart the required solubility for pre-polymer (p0) in the medium (M). The exact nature of this polymer chain may vary to quite a large extent and it can be adjusted, case by case, according to the medium (M) used. The type of fabric conditioning composition into which it is desired to introduce the polymer of the dispersion should also be considered.

Typically, the polymer chain [A] can be selected from the homo- and copolymers (random, gradient or block) resulting from the polymerization of non-ionic monomers [An] and cationic monomers [Ac].

As used herein, the term “nonionic monomer” means a monomer without charge, typically such as acrylamide and N,N-dimethylacrylamide.

Exemplary non-ionic monomer [An] which can be used in the present invention include but not limited to: meth)acrylamide, N-methyl(meth)acrylamide, N-ethyl(meth)acrylamide, N-propyl(meth)acrylamide, N,N-dimethyl(meth) acrylamide, N,N-diethylacrylamide, N-vinylformamide, N-vinyl-N-methyl formamide, N-vinylacetamide, N-vinyl-N-methylacetamide, N-vinyl-N-ethylacetamide, N-vinyipropionamide, N-vinyl-N-methylpropionamide, N-vinylbutyramide, N-vinylpyrrolidone, N-vinylpiperidone, N-vinyl caprolactame, hydroxyethyl (meth)acrylate, hydroxypropyl (meth)acrylate, hydroxymethyl(meth)acrylamide, hydroxyethyl(meth)acrylamide, glycerol (meth)acrylate, N-Tris(hydroxymethyl)methyl]acrylamide, N-isporpylacrylamide or the combination thereof.

In another embodiment of the present invention, [A] represents a polymer chain derived from monomers comprising cationic monomers [Ac] and non-ionic monomers [An]. The cationic monomers [Ac] may be distributed randomly across the polymer chain comprised of [An] units. Alternatively the cationic monomers [Ac] may be concentrated towards either end of the chain (gradient of composition across the chain). Finally the cationic monomers [Ac] may form a discrete (homopolymeric) block of monomers on the polymer chain. All possibilities between the two extremes, a random distribution of cationic monomer and a block or multiblock distribution are possible.

In a further embodiment of the present invention, the mole ratio of the non-ionic monomers [An] to the cationic monomers [Ac] is between 15:1 to 2:1, preferably 9:1 to 4:1. Such polymer dispersions have better conditioning performance.

The non-ionic monomers [An] is defined above. The cationic monomers [Ac] which can be used in the present invention is selected from quaternary ammonium monomer bearing at least one carbon-carbon double bonds.

The examples of quaternary ammonium monomer include, but not limited to:
Trimethylammoniumpropylmethacrylamide salts;
(3-methacrylamidopropyl)trimethylammonium salts;
(3-acrylamidopropyl)trimethylammonium salts;
methacryloyloxyethyltrimethylammonium salts;
acryloyloxyethyltrimethylammonium salts;
methyldiethylammoniumethyl acrylate salts;
benzyldimethylammoniumethyle acrylate salts;
1-ethyl 2-vinylpyridinium salts;
1-ethyl 4-vinylpyridinium salts;
N-dimethyldiallylammonium salts;
dimethylaminopropylmethacrylamide N-(3-chloro-2-hydroxypropyl)trimethylammonium salts;
N¹-(3-(2-((3-methacrylamidopropyl)dimethylammonio)acetamido) propyl)-N¹,N¹,N³,N³,N³-pentamethylpropane-1,3-diaminium salts,
2-hydroxy-N1-(3-methacrylamidopropyl)-N, N¹,N³,N³,N³-pentamethylpropane-1,3-diaminium salts
the monomer of formula of

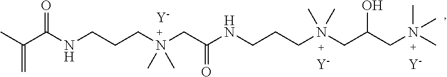

where Y⁻ is an anion, preferably chloride, methylsulfate or ethylsulfate.

In one preferred embodiment of the present invention, the quaternary ammonium monomer is the one or more selected from (3-acrylamidopropyl)trimethylammonium salts, N¹-(3-(2-((3-methacrylamidopropyl)dimethylammonio)acetamido)propyl)-N¹,N¹,N³,N³,N³-pentamethylpropane-1,3-diaminium salts (Triquat), or 2-hydroxy-N1-(3-methacrylamidopropyl)-N¹,N¹,N³,N³,N³-pentamethylpropane-1,3-diaminium salts (Diquat).

Triquat has the formula as below:

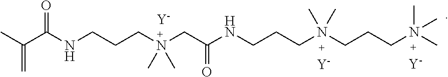

Diquat has the formula as below:

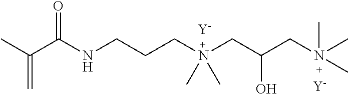

The salts of quaternary ammonium monomer can be, but not limited to chloride, bromide, methylsulfate or ethylsulfate salts.

According to the present description, the term “(meth)acrylate” refers collectively and alternatively to the acrylate and methacrylate and the term “(meth)acrylamide” refers collectively and alternatively to the acrylamide and methacrylamide, so that, for example, “butyl (meth)acrylate” means butyl acrylate and/or butyl methacrylate.

It should moreover be noted that the polymer chain [A] of the pre-polymer (p0) has more particularly a number-average molar mass of less than 50 000 g/mol, for example, less than 20 000 g/mol, and more than 500 g/mol. Typically, the polymer chain [A] has a number-average molecular weight between 1 000 and 10 000 g/mol. Preferably, the polymer chain [A] has a molar mass between 2 000 and 5 000 g/mol. For the purpose of the present invention, the number-average molecular weight can be for example measured by steric exclusion chromatography, using polyethylene glycol as standard or triple detection (GPC).

3. The Pre-Polymer (p0)

The pre-polymer (p0) is “soluble in a medium (M)” which means that the pre-polymer may be solubilized in the medium (M) without phase separation on the macroscopic scale at the pre-polymer concentration used in step (E), in the absence of the monomer (m). Concretely, the pre-polymer (p0) is solubilized in medium (M) at the beginning of step (E). To this end, the polymer chain [A] included in the pre-polymer (p0) is soluble in the medium (M).

The pre-polymer (p0) of the present invention may typically be obtained by a preparation step (E⁰) of controlled radical polymerization of a composition comprising:
non-ionic monomers [An] and preferably cationic monomers [Ac] as defined above;
a radical polymerization control agent including a group (R¹¹)x-Z¹¹—C(═S)—Z¹²—, wherein R¹¹, x, Z¹¹, and Z¹² being defined above, (preferably xanthate, dithiocarbamate, dithiocarbazate, trithiocarbonate, dithioester or dithiobenzoate); and
a free-radical polymerization initiator which is typically as defined here-after.

The group (R¹¹)x-Z¹¹—C(═S)—Z¹²— of pre-polymer (p0), which may especially be a thiocarbonylthio group, is typically introduced via the control agent used in the controlled radical polymerization performed in the above-mentioned step (E⁰), which is typically a RAFT or MADIX control agent. According to a specific embodiment, the control agent used in step (E⁰) may contain serval groups of this type (for example several thiocarbonylthio groups).

The radical polymerization control agent used in step (E⁰) may especially have the formula (F) below:

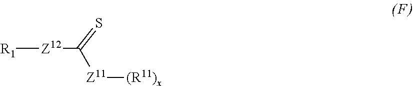

in which:
R¹¹, x, Z¹¹, and Z¹² being defined above for pre-polymer (p0); and
R₁ represents:
   an optionally substituted alkyl, acyl, aryl, aralkyl, alkene or alkyne group,
   a saturated or unsaturated, aromatic, optionally substituted carbocycle or heterocycle, or
   a polymer chain.

R₁, when substituted, may be substituted with optionally substituted phenyl groups, optionally substituted aromatic groups, saturated or unsaturated carbocycles, saturated or unsaturated heterocycles, or groups selected from the following: alkoxycarbonyl or aryloxycarbonyl (—COOR), carboxyl (—COOH), acyloxy (—O₂CR), carbamoyl (—CONR), cyano (—CN), alkylcarbonyl, alkylarylcarbonyl, arylcarbonyl, arylalkylcarbonyl, phthalimido, maleimido, succinimido, amidino, guanidimo, hydroxyl (—OH), amino (—NR), halogen, perfluoroalkyl CₙF₂ₙ₊₁, allyl, epoxy, alkoxy (—OR), S-alkyl, S-aryl, groups of hydrophilic or ionic nature such as alkali metal salts of carboxylic acids, alkali metal salts of sulfonic acid, polyalkylene oxide chains (PEO, PPO), cationic substituents (quaternary ammonium salts), R representing an alkyl or aryl group, or a polymer chain.

According to one particular embodiment, R₁ is a substituted or unsubstituted, preferably substituted, alkyl group.

The optionally substituted alkyl, acyl, aryl, aralkyl or alkyne groups to which reference is made in the present description generally contain 1 to 20 carbon atoms, preferably 1 to 12 and more preferentially 1 to 9 carbon atoms. They may be linear or branched. They may also be substituted with oxygen atoms, in particular in the form of esters or sulfur or nitrogen atoms.

Among the alkyl radicals, mention may be made especially of methyl, ethyl, propyl, butyl, pentyl, isopropyl, tert-butyl, pentyl, hexyl, octyl, decyl or dodecyl radicals.

For the purposes of the present description, the alkyne groups are radicals generally containing from 2 to 10 carbon atoms, and contain at least one acetylenic unsaturation, such as the acetylenyl radical.

For the purposes of the present description, the acyl groups are radicals generally containing from 1 to 20 carbon atoms with a carbonyl group.

Among the aryl radicals which may be used according to the invention, mention may be made in particular of the phenyl radical, optionally substituted especially with a nitro or hydroxyl function.

Among the aralkyl radicals, mention may be made in particular of the benzyl or phenethyl radical, optionally substituted especially with a nitro or hydroxyl function.

When R₁ is a polymer chain, this polymer chain may be derived from a radical or ionic polymerization or derived from a polycondensation.

Advantageously, in step (E⁰), the radical polymerization control agent is a xanthate compound, for instance O-ethyl-S-(1-methoxycarbonyl ethyl) xanthate of formula (CH₃CH(CO₂CH₃))S(C═S)OCH₂CH₃.

A control agent that is particularly suited to the implementation of step (E⁰) is the compound sold by the company Solvay under the name Rhodixan® A1.

The number-average molecular weight (Mn) of the pre-polymer (p0) is typically from 1 000 to 100 000 g/mol, for example between 2 000 to 50 000 g/mol and in particular between 2500 to 10 000 g/mol.

4. The Aqueous Medium (M)

The water is preferably present in the medium (M) in an amount of at least 50% by weight, preferably at least 60% by weight based on the total weight of the aqueous medium.

The water miscible solvent is preferably present in the medium (M) in an amount of at least 15% by weight of the total weight of the medium, for example between 20 and 50%, for example, at least 25%, or at least 30%, e.g. between 25 and 40% by weight.

In some cases, the water miscible solvent may however be present in the medium (M) in an amount of more than 40% by weight of the total weight of the medium, for example, at least 45%, preferably 50% or more, possible up to 100%.

Suitable water miscible solvents include saturated or unsaturated monohydric alcohols and polyhydric alcohols, as well as alkylether diols such as, for example, methanol, ethanol, isopropanol, benzyl alcohol, glycol, such as, for example, ethylene glycol, polyethylene glycol, propylene glycol, hexylene glycol, ethylene glycol monoethyl ether, ethylene glycol mono n-butyl ether (EGMBE), propylene glycol monoethyl or and diethylene glycol monomethyl ether.

According to one embodiment of the invention, the water miscible solvent is preferably a glycol, for example, monoethylene glycol and/or tripropylene glycol.

The aqueous medium (M) of the present invention is used as a liquid carrier, typically presents as a continuous phase, and comprising at least one water miscible solvent, typically glycol, and optionally salts or else water-soluble compounds.

5. Ethylenically Unsaturated Monomer

At least one ethylenically unsaturated hydrophobic monomer (m) is used to prepare the polymer dispersion which imparts hydrophobicity to the polymers.

The monomer (m) which can be used in the present invention is the one or more selected from the group consisting of C₁-C₁₀ alkyl (meth)acrylate, vinyl esters of a carboxylic acid, and vinyl nitriles.

According to the present invention, alkyl (meth)acrylate of “Cₙ” means an alkyl (meth)acrylate with the alkyl group containing n carbon atoms. For example, “alkyl (meth)acrylate of C₈” means an alkyl (meth)acrylate with the alkyl group containing 8 carbon atoms. Accordingly, C₁-C₁₀ alkyl (meth)acrylate means an alkyl (meth)acrylate with the alkyl group containing 1 to 10 carbon atoms.

Exemplary include, but not limited to, methyl (meth)acrylate, ethyl (meth)acrylate, propyl (meth)acrylate, butyl (meth)acrylate, pentyl (meth)acrylate, hexyl (meth)acrylate, or 2-ethylhexyl acrylate.

Exemplary vinyl esters of a carboxylic acid includes, but not limited to, vinyl acetate, vinyl versatate or vinyl propionate.

In another one embodiment of the present invention, the monomer (m) is the one or more selected from butyl acrylate, 2-ethylhexyl acrylate, and vinyl acetate.

According to the present invention, the weight ratio of the pre-polymer (p0) to the ethylenically unsaturated monomer (m) is denoted as R_{HH}. It has been found that the weight ratio of the pre-polymer (p0) to the ethylenically unsaturated monomer (m) is between 1:3 to 1:15, preferably 1:5 to 1:20, Such polymer dispersions have better conditioning performance than those out of the range.

6. The Free-Radical Polymerization Initiator

Any source of free radicals which is known per se as being suitable for polymerization processes in a medium comprising water miscible solvent may be used in steps (E⁰) and (E) of the polymerization of the invention.

The radical polymerization initiator may, for example, be selected from the following initiators:
peroxyoctoate, t-butyl peroxyneodecanoate, t-butyl peroxyisobutyrate, lauroyl peroxide, t-amyl peroxypivalate, t-butyl peroxypivalate, dicumyl peroxide, benzoyl peroxide, sodium persulphate, potassium persulfate, ammonium persulfate,
azo compounds such as: 2-2′-azobis(isobutyronitrile), 2,2′-azobis(2-butanenitrile), 2,2′-Azodi(2-methylbutyronitrile), 4,4′-azobis(4-pentanoic acid), 1,1′-azobis(cyclohexanecarbonitrile), 2-(t-butylazo)-2-cyanopropane, 2,2′-azobis[2-méthyl-N-(1,1)-bis(hydroxymethyl)-2-hydroxyethyl]propionamide, 2,2′-azobis(2-methyl-N-hydroxyethyl]propionamide, 2,2′-azobis(N,N′-dimethyleneisobutyramidine)dichloride, 2,2′-azobis(2-amidinopropane)dichloride, 2,2′-azobis(N,N′-diméthyleneisobutyramide), 2,2′-azobis(2-methyl-N-[1,1-bis(hydroxymethyl)-2-hydroxyethyl]propionamide), 2,2′-azobis(2-methyl-N-[1,1-bis(hydroxymethyl)ethyl]propionamide), 2,2′-azobis[2-methyl-N-(2-hydroxyethyl)propionamide] or 2,2′-azobis(isobutyramide)dihydrate,
redox systems comprising combinations such as:
mixtures of hydrogen peroxide, alkyl peroxide, hydroperoxides, peresters, percarbonates and the like and any iron salts, titanous salts, zinc formaldehyde sulfoxylate or sodium formaldehyde sulfoxylate, and, reducing sugars, alkali metal bisulphite, sulfur dioxide and alkali metal sulfites
alkali metal or ammonium persulfates, perborate or perchlorate in combination with an alkali metal bisulfite, such as sodium metabisulfite, and reducing sugars, sulfur dioxide and alkali metal sulfites
alkali metal persulfates in combination with tertiary amines
alkali metal persulfates in combination with alkali metal hypophosphites
mixtures of water-soluble bromates (for example alkali metal bromates) with water-soluble sulfites (for example alkali metal sulfites),
alkali metal or ammonium persulfates, perborate or perchlorate in combination with ascorbic or erythorbic acids

7. The Polymer Dispersion

According to the present description, “polymer dispersion” denotes a composition comprising a polymer in the form of microscopically observable particles having dimensions between 10 nm and 1 microns (most commonly between 50 nm and 850 nm, and typically between 200 and 600 nm) dispersed within a phase consisting of an aqueous medium (M). A dispersion of polymers, within the meaning given to the term as used in the present description, should be distinguished from a solution of polymers, which does not contain polymers in the form of microscopically observable particles. Typically, the dispersion has a milky appearance and widely scatters light, whereas a solution usually has a transparent appearance.

The polymer dispersion prepared by the step (E) of radical polymerization in an aqueous medium (M) usually has a solid content of 10-40 wt. %, preferably 30 to 40 wt. %, based on the total weight of the polymer dispersion.

The polymer dispersion can be diluted to required content before adding to the fabric conditioning composition, for example, diluted to 0.01 to 10 wt. % (solid content) based on the total weight of the dispersion.

II. The Fabric Conditioning Composition

The fabric conditioning compositions of the present invention comprises the polymer dispersion as described above, they shows remarkable fabric conditioning performance without necessarily adding conventional quaternary ammonium compounds as softener.

The fabric conditioning composition comprising the polymer dispersion can be a concentrated liquid, or can be diluted to required concentration. According to one embodiment of the present invention, the polymer dispersion is present in an amount of from 0.0001 to 20 wt. % based on the total weight of the composition. In another embodiment, the polymer dispersion is present in an amount of from 0.001 to 10 wt % based on the total weight of the composition. In still another embodiment, the polymer dispersion is present in an amount of from 0.001 to 8 wt % based on the total weight of the composition.

1. Quaternary Ammonium Compounds

The fabric conditioning composition of the present invention can further comprises quaternary ammonium compounds, particularly ester quaternary ammonium compounds.

Preferred ester quaternary ammonium compounds of the present invention include

TET: Di(tallowcarboxyethyl)hydroxyethyl methyl ammonium methylsulfate,

TEO Di(oleocarboxyethyl)hydroxyethyl methyl ammonium methylsulfate,

TES: Distearyl hydroxyethyl methyl ammonium methylsulfate,

TEHT: Di(hydrogenated tallow-carboxyethyl)hydroxyethyl methyl ammonium methylsulfate,

TEP: Di(palmiticcarboxyethyl)hydroxyethyl methyl ammonium methylsulfate, and

DEEDMAC: Dimethylbis[2-[(1-oxooctadecyl)oxy]ethyl]ammonium chloride.

In one embodiment, the quaternary ammonium compound is present in an amount of from 0.5 to 20 wt % based on the total weight of the composition. In another embodiment, the quaternary ammonium compound is present in an amount of from 1 to 10 wt % based on the total weight of the composition. In still another embodiment, the quaternary ammonium is present in an amount of from 3 to 8 wt % based on the total weight of the composition.

2. Polysaccharide

The term “cationic polysaccharide” as used herein means a polysaccharide or a derivative thereof that has been chemically modified to provide the polysaccharide or the derivative thereof with a net positive charge in a pH neutral aqueous medium. The cationic polysaccharide may also include those that are non permanently charged, e.g. a derivative that can be cationic below a given pH and neutral above that pH. Non-modified polysaccharides, such as starch, cellulose, pectin, carageenan, guars, xanthans, dextrans, curdlans, chitosan, chitin, and the like, can be chemically modified to impart cationic charges thereon. A common chemical modification incorporates quaternary ammonium substituents to the polysaccharide backbones. Other suitable cationic substituents include primary, secondary or tertiary amino groups or quaternary sulfonium or phosphinium groups. Additional chemical modifications may include cross-linking, stabilization reactions (such as alkylation and esterification), phophorylations, hydrolyzations.

The term “nonionic polysaccharide” as used herein refers to a polysaccharide or a derivative thereof that has been chemically modified to provide the polysaccharide or the derivative thereof with a net neutral charge in a pH neutral aqueous medium; or a non-modified polysaccharide.

In one aspect, the composition of the present invention comprises at least one cationic polysaccharide. In one embodiment, the composition comprises only one cationic polysaccharide.

The cationic polysaccharide can be obtained by chemically modifying polysaccharides, generally natural polysaccharides. By such modification, cationic side groups can be introduced into the polysaccharide backbone. In one embodiment, the cationic groups borne by the cationic polysaccharide according to the present invention are quaternary ammonium groups.

The cationic polysaccharides of the present invention include but are not limited to

cationic guar and derivatives thereof, cationic cellulose and derivatives thereof, cationic starch and derivatives thereof, cationic callose and derivatives thereof, cationic xylan and derivatives thereof, cationic mannan and derivatives thereof, cationic galactomannose and derivative thereof.

Cationic celluloses suitable for the present invention include cellulose ethers comprising quaternary ammonium groups, cationic cellulose copolymers or celluloses grafted with a water-soluble quaternary ammonium monomer.

The cellulose ethers comprising quaternary ammonium groups are described in French patent 1,492,597 and in particular include the polymers sold under the names “JR” (JR 400, JR 125, JR 30M) or “LR” (LR 400, LR 30M) by the company Dow. These polymers are also defined in the CTFA dictionary as hydroxyethylcellulose quaternary ammoniums that have reacted with an epoxide substituted with a trimethylammonium group. Suitable cationic celluloses also include LR3000 KC from company Solvay.

The cationic cellulose copolymers or the celluloses grafted with a water-soluble quaternary ammonium monomer are described especially in patent U.S. Pat. No. 4,131,576, such as hydroxyalkylcelluloses, for instance hydroxymethyl-, hydroxyethyl- or hydroxypropylcelluloses grafted especially with a methacryloyl-ethyltrimethylammonium, methacrylamidopropyltrimethylammonium or dimethyl-diallylammonium salt. The commercial products corresponding to this definition are more particularly the products sold under the names Celquat® L 200 and Celquat® H 100 by the company Akzo Nobel.

Cationic starches suitable for the present invention include the products sold under Polygelo® (cationic starches from Sigma), the products sold under Softgel®, Amylofax® and Solvitose® (cationic starches from Avebe), CATO from National Starch.

Suitable cationic galactomannose include, for example, Fenugreek Gum, Konjac Gum, Tara Gum, Cassia Gum.

In one embodiment, the cationic polysaccharide is a cationic guar. Guars are polysaccharides composed of the sugars galactose and mannose. The backbone is a linear chain of β 1,4-linked mannose residues to which galactose residues are 1,6-linked at every second mannose, forming short side-branches. Within the context of the present invention, the cationic guars are cationic derivatives of guars.

In the case of the cationic polysaccharide, such as the cationic guar, the cationic group may be a quaternary ammonium group bearing 3 radicals, which may be identical or different, preferably chosen from hydrogen, alkyl, hydroxyalkyl, epoxyalkyl, alkenyl, or aryl, preferably containing 1 to 22 carbon atoms, more particularly 1 to 14 and advantageously 1 to 3 carbon atoms.

The counterion is generally a halogen. One example of the halogen is chlorine.

Examples of the quaternary ammonium group include: 3-chloro-2-hydroxypropyl trimethyl ammonium chloride (CHPTMAC), 2,3-epoxypropyl trimethyl ammonium chloride (EPTAC), diallyldimethyl ammonium chloride (DMDAAC), vinylbenzene trimethyl ammonium chloride, trimethylammonium ethyl metacrylate chloride, methacrylamidopropyltrimethyl ammonium chloride (MAPTAC), and tetraalkylammonium chloride.

One example of the cationic functional group in the cationic polysaccharides, such as the cationic guars, is trimethylamino(2-hydroxyl)propyl, with a counter ion. Various counter ions can be utilized, including but not limited to halides, such as chloride, fluoride, bromide, and iodide, sulfate, notrate, methylsulfate, and mixtures thereof.

The cationic guars of the present invention may be chosen from the group consisting of:

cationic hydroxyalkyl guars, such as cationic hydroxyethyl guar, cationic hydroxypropyl guar, cationic hydroxybutyl guar, and cationic carboxylalkyl guars including cationic carboxymethyl guar, cationic alkylcarboxy guars such as cationic carboxylpropyl guar and cationic carboxybutyl guar, cationic carboxymethylhydroxypropyl guar.

In one embodiment, the cationic guars of the present invention are guars hydroxypropyltrimonium chloride or hydroxypropyl guar hydroxypropyltrimonium chloride.

The cationic polysaccharide, such as the cationic guars, of the present invention may have an average Molecular Weight (Mw) of between 100,000 daltons and 3,500,000 daltons, preferably between 100,000 daltons and 1,500,000 daltons, more preferably between 100,000 daltons and 1,000,000 daltons.

In one embodiment, the composition comprises from 0.05 to 10 wt % of the cationic polysaccharide according to the present invention based on the total weight of the composition. In another embodiment, the composition comprises from 0.05 to 5 wt % of the cationic polysaccharide based on the total weight of the composition. In still another embodiment, the composition comprises from 0.2 to 2 wt % of the cationic polysaccharide based on the total weight of the composition.

In the context of the present application, the term “Degree of Substitution (DS)” of cationic polysaccharides, such as cationic guars, is the average number of hydroxyl groups substituted per sugar unit. DS may notably represent the number of the carboxymethyl groups per sugar unit. DS may be determined by titration.

In one embodiment, the DS of the cationic polysaccharide, such as the cationic guar, is in the range of 0.01 to 1. In another embodiment, the DS of the cationic polysaccharide, such as the cationic guar, is in the range of 0.05 to 1. In still another embodiment, the DS of the cationic polysaccharide, such as the cationic guar, is in the range of 0.05 to 0.2.

In the context of the present application, “Charge Density (CD)” of cationic polysaccharides, such as cationic guars, means the ratio of the number of positive charges on a monomeric unit of which a polymer is comprised to the molecular weight of said monomeric unit.

In one embodiment, the CD of the cationic polysaccharide, such as the cationic guar, is in the range of 0.1 to 3 (meq/gm). In another embodiment, the CD of the cationic polysaccharide, such as the cationic guar, is in the range of 0.1 to 2 (meq/gm). In still another embodiment, the CD of the cationic polysaccharide, such as the cationic guar, is in the range of 0.1 to 1 (meq/gm).

In one aspect, the composition of the present invention comprises at least one nonionic polysaccharide. In one embodiment, the composition comprises only one nonionic polysaccharide.

The nonionic polysaccharide can be a modified nonionic polysaccharide or a non-modified nonionic polysaccharide. The modified nonionic polysaccharide may comprise hydroxyalkylations. In the context of the present application, the degree of hydroxyalkylation (molar substitution or MS) of the modified nonionic polysaccharides means the number of alkylene oxide molecules consumed by the number of free hydroxyl functions present on the polysaccharides. In one embodiment, the MS of the modified nonionic polysaccharide is in the range of 0 to 3. In another embodiment, the MS of the modified nonionic polysaccharide is in the range of 0.1 to 3. In still another embodiment, the MS of the modified nonionic polysaccharide is in the range of 0.1 to 2.

The nonionic polysaccharide of the present invention may be especially chosen from glucans, modified or non-modified starches (such as those derived, for example, from cereals, for instance wheat, corn or rice, from vegetables, for instance yellow pea, and tubers, for instance potato or cassava), amylose, amylopectin, glycogen, dextrans, celluloses and derivatives thereof (methylcelluloses, hydroxyalkylcelluloses, ethylhydroxyethylcelluloses), mannans, xylans, lignins, arabans, galactans, galacturonans, chitin, chitosans, glucuronoxylans, arabinoxylans, xyloglucans, glucomannans, pectic acids and pectins, arabinogalactans, carrageenans, agars, gum arabics, gum tragacanths, ghatti gums, karaya gums, carob gums, galactomannans such as guars and nonionic derivatives thereof (hydroxypropyl guar), and mixtures thereof.

Among the celluloses that are especially used are hydroxyethylcelluloses and hydroxypropylcelluloses. Mention may be made of the products sold under the names Klucel® EF, Klucel® H, Klucel® LHF, Klucel® MF and Klucel® G by the company Aqualon, and Cellosize® Polymer PCG-10 by the company Amerchol, and HEC, HPMC K200, HPMC K35M by the company Ashland.

In one embodiment, the nonionic polysaccharide is a nonionic guar. The nonionic guar can be modified or non-modified. The non-modified nonionic guars include the products sold under the name Vidogum® GH 175 by the company Unipectine and under the names Meypro®-Guar 50 and Jaguar® C by the company Solvay. The modified nonionic guars are especially modified with C₁-C₆ hydroxyalkyl groups. Among the hydroxyalkyl groups that may be mentioned, for example, are hydroxymethyl, hydroxyethyl, hydroxypropyl and hydroxybutyl groups. These guars are well known in the prior art and can be prepared, for example, by reacting the corresponding alkene oxides such as, for example, propylene oxides, with the guar so as to obtain a guar modified with hydroxypropyl groups.

The nonionic polysaccharide, such as the nonionic guar, of the present invention may have an average Molecular Weight (Mw) of between 100,000 daltons and 3,500,000 daltons, preferably between 500,000 daltons and 3,500,000 daltons.

In one embodiment, the composition comprise from 0.05 to 10 wt % of the nonionic polysaccharide according to the present invention based on the total weight of the composition. In another embodiment, the composition comprises from 0.05 to 5 wt % of the nonionic polysaccharide based on the total weight of the composition. In still another embodiment, the composition comprises from 0.2 to 2 wt % of the nonionic polysaccharide based on the total weight of the composition.

3. Fragrance Material or Perfume

In another aspect of the present invention, the composition may further comprise a fragrance material or a perfume.

As used herein, the term “fragrance material or perfume” means any organic substance or composition which has a desired olfactory property and is essentially non-toxic. Such substances or compositions include all fragrance material and perfumes that are commonly used in perfumery or in household compositions (laundry detergents, fabric conditioning compositions, soaps, all-purpose cleaners, bathroom cleaners, floor cleaners) or personal care compositions. The compounds involved may be natural, semi-synthetic or synthetic in origin.

Preferred fragrance materials and perfumes may be assigned to the classes of substance comprising the hydrocarbons, aldehydes or esters. The fragrances and perfumes also include natural extracts and/or essences, which may comprise complex mixtures of constituents, i.e. fruits such as almond, apple, cherry, grape, pear, pineapple, orange, lemon, strawberry, raspberry and the like; musk, flower scents such as lavender, jasmine, lily, magnolia, rose, iris, carnation and the like; herbal scents such as rosemary, thyme, sage and the like; woodland scents such as pine, spruce, cedar and the like.

Non limitative examples of synthetic and semi-synthetic fragrance materials and perfumes are 7-acetyl-1,2,3,4,5,6,7,8-octahydro-1,1,6,7-tetramethylnaphthalene, α-ionone, β-ionone, γ-ionone, α-isomethylionone, methylcedrylone, methyl dihydrojasmonate, methyl 1,6,10-trimethyl-2,5,9-cyclododecatrien-1-yl ketone, 7-acetyl-1,1,3,4,4,6-hexamethyltetralin, 4-acetyl-6-tert-butyl-1,1-dimethylindane, hydroxyphenylbutanone, benzophenone, methyl b-naphthyl ketone, 6-acetyl-1,1,2,3,3,5-hexamethylindane, 5-acetyl-3-isopropyl-1,1,2-,6-tetramethylindane, 1-dodecanal, 4-(4-hydroxy-4-methylpentyl)-3-cyclohex-ene-1-carboxaldehyde, 7-hydroxy-3,7-dimethyloctanal, 10-undecen-1-al, isohexenylcyclohexylcarboxaldehyde, formyltricyclodecane, condensation products of hydroxycitronellal and methyl anthranilate, condensation products of hydroxycitronellal and indole, condensation products of phenylacetaldehyde and indole, 2-methyl-3-(para-tert-butylphenyl)propionaldehyde, ethylvanillin, heliotropin, hexylcinnamaldehyde, amylcinnamaldehyde, 2-methyl-2-(isopropylphenyl)propionaldehyde, coumarin, γ-decalactone, cyclopentadecanolide, 16-hydroxy-9-hexadecenoic acid lactone, 1,3,4,6,7,8-hexahydro-4,6,6,7,8,8-hexamethylcyclopenta-g-benzopyran, β-naphthol methyl ether, ambroxane, dodecahydro-3a,6,6,9a-tetramethylnaphtho[2,1 b]furan, cedrol, 5-(2,2,3-trimethylcyclopent-3-enyl)-3-methylpentan-2-ol, 2-ethyl-4-(2,2,3-trimethyl-3-cyclopenten-1-yl)-2-buten-1-ol, caryophyllene alcohol, tricyclodecenyl propionate, tricyclodecenyl acetate, benzyl salicylate, cedryl acetate, and tert-butylcyclohexyl acetate.

Particular preference is given to the following hexylcinnamaldehyde, 2-methyl-3-(tert-butylphenyl)propionaldehyde, 7-acetyl-1,2,3,4,5,6,7,8-octahydro-1,1,6,7-tetramethylnaphthalene, benzyl salicylate, 7-acetyl-1,1,3,4,4,6-hexamethyltetralin, para-tert-butylcyclohexyl acetate, methyl dihydrojasmonate, (β-naphthol methyl ether, methyl g-naphthyl ketone, 2-methyl-2-(para-isopropylphenyl)propionaldehyde, 1,3,4,6,7,8-hexahydro-4,6,6,7,8,8-hexamethylcyclopenta-g-2-benzopyran, dodecahydro-3a,6,6,9a-tetramethylnaphtho[2,1 b]furan, anisaldehyde, coumarin, cedrol, vanillin, cyclopentadecanolide, tricyclodecenyl acetate and tricyclodecenyl propionates.

Other fragrance materials and perfumes are essential oils, resinoids and resins from a large number of sources, such as, Peru balsam, olibanum resinoid, styrax, labdanum resin, nutmeg, cassia oil, benzoin resin, coriander, clary sage, eucalyptus, geranium, lavender, mace extract, neroli, nutmeg, spearmint, sweet violet leaf, valerian and lavandin.

Some or all of the fragrance materials and perfumes may be encapsulated, typical perfume components which it is advantageous to encapsulate, include those with a relatively low boiling point. It is also advantageous to encapsulate perfume components which have a low Clog P (i.e. those which will be partitioned into water), preferably with a Clog P of less than 3.0. As used herein, the term “Clog P” means the calculated logarithm to base 10 of the octanol/water partition coefficient (P).

Further suitable fragrance materials and perfumes include: phenylethyl alcohol, terpineol, linalool, linalyl acetate, geraniol, nerol, 2-(1,1-dimethylethyl)cyclo-hexanol acetate, benzyl acetate, and eugenol.

The fragrance material or perfume can be used as single substance or in a mixture with one another.

Perfumes frequently include solvents or diluents, for example: ethanol, isopropanol, diethylene glycol monoethyl ether, dipropylene glycol, diethyl phthalate and triethyl citrate.

In one embodiment, the composition comprises from 0.01 to 10 wt % of the fragrance material or perfume based on the total weight of the composition. In another embodiment, the composition comprises from 0.1 to 5 wt % of the fragrance material or perfume based on the total weight of the composition. In still another embodiment, the composition comprises from 0.1 to 2 wt % of the fragrance material or perfume based on the total weight of the composition.

4. Other Additives

In still another aspect of the present invention, the composition may comprise one or more of the following optional ingredients: dispersing agents, stabilizers, rheology modifying agent, pH control agents, colorants, brighteners, fatty alcohols, fatty acids, dyes, odor control agent, pro-perfumes, cyclodextrins, solvents, preservatives, chlorine scavengers, anti-shrinkage agents, fabric crisping agents, spotting agents, anti-oxidants, anti-corrosion agents, bodying agents, drape and form control agents, smoothness agents, static control agents, wrinkle control agents, sanitization agents, disinfecting agents, germ control agents, mold control agents, mildew control agents, antiviral agents, anti-microbials, drying agents, stain resistance agents, soil release agents, malodor control agents, fabric refreshing agents, chlorine bleach odor control agents, dye fixatives, dye transfer inhibitors, color maintenance agents, color restoration/rejuvenation agents, anti-fading agents, whiteness enhancers, anti-abrasion agents, wear resistance agents, fabric integrity agents, anti-wear agents, defoamers and anti-foaming agents, rinse aids, UV protection agents, sun fade inhibitors, insect repellents, anti-allergenic agents, enzymes, flame retardants, water proofing agents, fabric comfort agents, water conditioning agents, stretch resistance agents, and mixtures thereof. Such optional ingredients may be added to the composition in any desired order.

In referring to optional ingredients, without this having to be regarded as an exhaustive description of all possibilities, which, on the other hand, are well known to the person skilled in the art, the following may be mentioned
a) other products that enhance the conditioning performance of the composition, such as silicones, amine oxides, anionic surfactants, such as lauryl ether sulphate or lauryl sulphate, sulphosuccinates, amphoteric surfactants, such as amphoacetate, nonionic surfactants such as polysorbate, polyglucoside derivatives, and cationic polymers such as polyquaternium, etc.;
b) stabilising products, such as salts of amines having a short chain, which are quaternised or non-quaternised, for example of triethanolamine, N-methyldiethanolamine, etc., and also non-ionic surfactants, such as ethoxylated fatty alcohols, ethoxylated fatty amines, polysorbate, and ethoxylated alkyl phenols; typically used at a level of from 0 to 15% by weight of the composition;
c) products that improve viscosity control, which is preferably added when the composition comprises high concentrations of fabric conditioning active (such as the quaternary ammonium compound); for example inorganic salts, such as calcium chloride, magnesium chloride, calcium sulphate, sodium chloride, etc.; products which can be used improve the stability in concentrated compositions, such as compounds of the glycol type, such as, glycerol, polyglycerols, ethylene glycol, polyethylene glycols, dipropylene glycol, other polyglycols, etc.; and thickening agents for diluted compositions, for example, natural polymers derived from cellulose, guar, etc. or synthetic polymers, such as acrylamide based polymers (e.g. Flosoft 222 from SNF company), hydrophobically-modified ethoxylated urethanes (e.g. Acusol 880 from Dow company);
d) components for adjusting the pH, which is preferably from 2 to 8, such as any type of inorganic and/or organic acid, for example hydrochloric, sulphuric, phosphoric, citric acid etc.;
e) agents that improve soil release, such as the known polymers or copolymers based on terephthalates;
f) bactericidal preservative agents;
g) other products such as antioxidants, colouring agents, perfumes, germicides, fungicides, anti-corrosive agents, anti-crease agents, opacifiers, optical brighteners, pearl lustre agents, etc.

The composition may comprise a silicone compound. The silicone compound of the invention can be a linear or branched structured silicone polymer. The silicone of the present invention can be a single polymer or a mixture of polymers. Suitable silicone compounds include polyalkyl silicone, amonosilicone, siloxane, polydimethyl siloxane, ethoxylated organosilicone, propoxylated organosilicone, ethoxylated/propoxylated organosilicone and mixture thereof. Suitable silicones include but are not limited to those available from Wacker Chemical, such as Wacker® FC 201 and Wacker® FC 205.

The composition may comprise a cross-linking agent. Following is a non-restrictive list of cross-linking agents: methylene bisacrylamide (MBA), ethylene glycol diacrylate, polyethylene glycol dimethacrylate, diacrylamide, triallylamine, cyanomethylacrylate, vinyl oxyethylacrylate or methacrylate and formaldehyde, glyoxal, compounds of the glycidyl ether type such as ethyleneglycol diglycidyl ether, or the epoxydes or any other means familiar to the expert permitting cross-linking.

The composition may comprise at least one surfactant system. A variety of surfactants can be used in the composition of the invention, including cationic, nonionic and/or amphoteric surfactants, which are commercially available from a number of sources. For a discussion of surfactants, see Kirk-Othmer, Encyclopedia of Chemical Technology, Third Edition, volume 8, pages 900-912. Preferably, the composition comprises a surfactant system in an amount effective to provide a desired level of softness to fabrics, preferably between about 5 and about 10 wt %.

The composition may comprise a dye, such as an acid dye, a hydrophobic dye, a basic dye, a reactive dye, a dye conjugate. Suitable acid dyes include azine dyes such as acid blue 98, acid violet 50, and acid blue 59, non-azine acid dyes such as acid violet 17, acid black 1 and acid blue 29. Hydrophobic dyes selected from benzodifuranes, methine, triphenylmethanes, napthalimides, pyrazole, napthoquinone, anthraquinone and mono-azo or di-azo dye chromophores. Suitable hydrophobic dyes are those dyes which do not contain any charged water solubilising group. The hydrophobic dyes may be selected from the groups of disperse and solvent dyes. Blue and violet anthraquinone and mono-azo dye are preferred. Basic dyes are organic dyes which carry a net positive charge. They deposit onto cotton. They are of particular utility for used in composition that contain predominantly cationic surfactants. Dyes may be selected from the basic violet and basic blue dyes listed in the Colour Index International. Preferred examples include triarylmethane basic dyes, methane basic dye, anthraquinone basic dyes, basic blue 16, basic blue 65, basic blue 66, basic blue 67, basic blue 71, basic blue 159, basic violet 19, basic violet 35, basic violet 38, basic violet 48; basic blue 3, basic blue 75, basic blue 95, basic blue 122, basic blue 124, basic blue 141. Reactive dyes are dyes which contain an organic group capable of reacting with cellulose and linking the dye to cellulose with a covalent bond. Preferably the reactive group is hydrolysed or reactive group of the dyes has been reacted with an organic species such as a polymer, so as to the link the dye to this species. Dyes may be selected from the reactive violet and reactive blue dyes listed in the Colour Index International. Preferred examples include reactive blue 19, reactive blue 163, reactive blue 182 and reactive blue, reactive blue 96. Dye conjugates are formed by binding direct, acid or basic dyes to polymers or particles via physical forces. Dependent on the choice of polymer or particle they deposit on cotton or synthetics. A description is given in WO2006/055787. Particularly preferred dyes are: direct violet 7, direct violet 9, direct violet 11, direct violet 26, direct violet 31, direct violet 35, direct violet 40, direct violet 41, direct violet 51, direct violet 99, acid blue 98, acid violet 50, acid blue 59, acid violet 17, acid black 1, acid blue 29, solvent violet 13, disperse violet 27 disperse violet 26, disperse violet 28, disperse violet 63, disperse violet 77 and mixtures thereof. The solid composition of the present invention may comprise one or more perfumes. The perfume is preferably present in an amount between 0.01 and 20 wt %, more preferably between 0.05 and 10 wt %, even more preferably between 0.05 and 5 wt %, most preferably between 0.05 and 1.5 wt %, based on the total weight of the solid composition.

The composition may comprise an antimicrobial. The antimicrobial may be a halogenated material. Suitable halogenated materials include 5-chloro-2-(2,4-dichlorophenoxy)phenol, o-Benzyl-p-chloro-phenol, and 4-chloro-3-methylphenol. Alternatively The antimicrobial may be a non-halogenated material. Suitable non-halogenated materials include 2-Phenylphenol and 2-(1-Hydroxy-1-methylethyl)-5-methylcyclohexanol. Phenyl ethers are one preferred sub-set of the antimicrobials. The antimicrobial may also be a bi-halogenated compound. Most preferably this comprises 4-4′ dichloro-2-hydroxy diphenyl ether, and/or 2,2-dibromo-3-nitrilopropionamide (DBNPA).

The composition may also comprise preservatives. Preferably only those preservatives that have no, or only slight, skin sensitizing potential are used. Examples are phenoxy ethanol, 3-iodo-2-propynylbutyl carbamate, sodium N-(hydroxymethyl)glycinate, biphenyl-2-ol as well as mixtures thereof.

The composition may also comprise antioxidants to prevent undesirable changes caused by oxygen and other oxidative processes to the solid composition and/or to the treated textile fabrics. This class of compounds includes, for example, substituted phenols, hydroquinones, pyrocatechols, aromatic amines and vitamin E.

The composition may comprise a hydrophobic agent. The hydrophobic agent may be present in an amount of from 0.05 to 1.0 wt %, preferably from 0.1 to 0.8 wt %, more preferably from 0.2 to 0.7 and most preferably from 0.4 to 0.7 wt % by weight of the total composition, for example from 0.2 to 0.5 wt %. The hydrophobic agent may have a C log P of from 4 to 9, preferably from 4 to 7, most preferably from 5 to 7.

Suitable hydrophobic agents include esters derived from the reaction of a fatty acid with an alcohol. The fatty acid preferably has a carbon chain length of from C₈ to C₂₂ and may be saturated or unsaturated, preferably saturated. Some examples include stearic acid, palmitic acid, lauric acid and myristic acid. The alcohol may be linear, branched or cyclic. Linear or branched alcohols have a preferred carbon chain length of from 1 to 6. Preferred alcohols include methanol, ethanol, propanol, isopropanol, sorbitol. Preferred hydrophobic agents include methyl esters, ethyl esters, propyl esters, isopropyl esters and sorbitan esters derived from such fatty acids and alcohols.

Non-limiting examples of suitable hydrophobic agents include methyl esters derived from fatty acids having a carbon chain length of from at least C₁₀, ethyl esters derived from fatty acids having a carbon chain length of from at least C₁₀, propyl esters derived from fatty acids having a carbon chain length of from at least C₈, isopropyl esters derived from fatty acids having a carbon chain length of from at least C₈, sorbitan esters derived from fatty acids having a carbon chain length of from at least C₁₆, and alcohols with a carbon chain length greater than C₁₀. Naturally occurring fatty acids commonly have a carbon chain length of up to C₂₂.

Some preferred materials include methyl undecanoate, ethyl decanoate, propyl octanoate, isopropyl myristate, sorbitan stearate and 2-methyl undecanol, ethyl myristate, methyl myristate, methyl laurate, isopropyl palmitate and ethyl stearate; more preferably methyl undecanoate, ethyl decanoate, isopropyl myristate, sorbitan stearate, 2-methyl undecanol, ethyl myristate, methyl myristate, methyl laurate and isopropyl palmitate.

Non-limiting examples of such materials include methyl undecanoate, ethyl decanoate, propyl octanoate, isopropyl myristate, sorbitan stearate and 2-methyl undecanol; preferably methyl undecanoate, ethyl decanoate, isopropyl myristate, sorbitan stearate and 2-methyl undecanol.

The composition may comprise an antifoam agent. The antifoam agent may be present in an amount of from 0.025 to 0.45 wt %, preferably 0.03 to 0.4 wt %, most preferably from 0.05 to 0.35 wt %, for example 0.07 to 0.4 wt %, by weight of the total composition and based on 100 percent antifoam activity. A wide variety of materials may be used as the antifoam agent, and antifoam agents are well known to those skilled in the art. See, for example, Kirk Othmer Encyclopedia of Chemical Technology, Third Edition, Volume 7, pages 430-447 (John Wiley and Sons, Inc., 1979).

Suitable antifoam agents include, for example, silicone antifoam compounds, alcohol antifoam compounds, for example 2-alkyl alcanol antifoam compounds, fatty acids, paraffin antifoam compounds, and mixtures thereof. By antifoam compound it is meant herein any compound or mixtures of compounds which act such as to depress the foaming or sudsing produced by a solution of a detergent composition, particularly in the presence of agitation of that solution.

Particularly preferred antifoam agents for use herein are silicone antifoam compounds defined herein as any antifoam compound including a silicone component. Many such silicone antifoam compounds also contain a silica component. The term ““silicone”” as used herein, and in general throughout the industry, encompasses a variety of relatively high molecular weight polymers containing siloxane units and hydrocarbyl group of various types like the polyorganosiloxane oils, such as polydimethyl-siloxane, dispersions or emulsions of polyorganosiloxane oils or resins, and combinations of polyorganosiloxane with silica particles wherein the polyorganosiloxane is chemisorbed or fused onto the silica. Silica particles are often hydrophobed, e.g. as Trimethylsiloxysilicate. Silicone antifoam agents are well known in the art and are, for example, disclosed in U.S. Pat. No. 4,265,779, issued May 5, 25 1981 and European Patent Application No. 89307851. 9, published Feb. 7, 1990. Other silicone antifoam compounds are disclosed in U.S. Pat. No. 3,455,839. Silicone defoamers and suds controlling agents in granular detergent compositions are disclosed in U.S. Pat. No. 3,933,672, 35 and in U.S. Pat. No. 4,652,392 issued Mar. 24, 1987. Examples of suitable silicone antifoam compounds are the combinations of polyorganosiloxane with silica particles commercially available from Dow Corning, Wacker Chemie and Momentive.

Other suitable antifoam compounds include the monocarboxylic fatty acids and soluble salts thereof. These materials are described in U.S. Pat. No. 2,954,347. The monocarboxylic fatty acids, and salts thereof, for use as antifoam agents typically have hydrocarbyl chains of about 10 to about 24 carbon atoms, preferably about 12 to about 18 carbon atoms like the tallow amphopolycarboxyglycinate commercially available under the trade name TAPAC. Suitable salts include the alkali metal salts such as sodium, potassium, and lithium salts, and ammonium and alkanolammonium salts.

Other suitable antifoam compounds include, for example, high molecular weight hydrocarbons such as paraffin, light petroleum odourless hydrocarbons, fatty esters (e. g. fatty acid triglycerides, glyceryl derivatives, polysorbates), fatty acid esters of monovalent alcohols, aliphatic C₁₈₋₄₀ ketones (e. g. stearone) N-alkylated amino triazines such as tri- to hexa-10 alkylmelamines or di- to tetra alkyldiamine chlortriazines formed as products of cyanuric chloride with two or three moles of a primary or secondary amine containing 1 to 24 carbon atoms, propylene oxide, bis stearic acid amide and monostearyl phosphates such as monostearyl alcohol phosphate ester and monostearyl di-alkali metal (e. g., K, Na, and Li) phosphates and phosphate esters, and nonionic polyhydroxyl derivatives. The hydrocarbons, such as paraffin and 15 haloparaffin, can be utilized in liquid form. The liquid hydrocarbons will be liquid at room temperature and atmospheric pressure, and will have a pour point in the range of about −40° C. and about 5° C., and a minimum boiling point not less than about 110° C. (atmospheric pressure). It is also known to utilize waxy hydrocarbons, preferably having a melting point below about 100° C. Hydrocarbon suds suppressers are described, for example, in U.S. Pat. No. 4,265,779. The hydrocarbons, thus, include aliphatic, alicyclic, aromatic, and heterocyclic saturated or unsaturated hydrocarbons having from about 12 to about 70 carbon atoms. The term “paraffin”, as used in this suds suppresser discussion, is intended to include mixtures of true paraffins and cyclic hydrocarbons. Copolymers of ethylene oxide and propylene oxide, particularly the mixed ethoxylated/propoxylated fatty alcohols with an alkyl chain length of from about 10 to about 16 carbon atoms, a degree of ethoxylation of from about 3 to about 30 and a degree of propoxylation of from about 1 to about 10, are also suitable antifoam compounds for use herein.

Other antifoam agents useful herein comprise the secondary alcohols (e.g., 2-alkyl alkanols as described in DE 40 21 265) and mixtures of such alcohols with silicone oils, such as the silicones disclosed in U.S. Pat. No. 4,798,679 and EP 150,872. The secondary alcohols include the C₆-C₁₆ alkyl alcohols having a C₁-C₁₆ chain like the 2-Hexyldecanol commercially available under the trade name ISOFOL16, 2-Octyldodecanol commercially available under the tradename ISOFOL20, and 2-butyl octanol, which is available under the trademark ISOFOL 12 from Condea. A preferred alcohol is 2-butyl octanol, which is available from Condea under the trademark ISOFOL 12. Mixtures of secondary alcohols are available under the trademark ISALCHEM 123 from Enichem. Mixed antifoam agents typically comprise mixtures of alcohol to silicone at a weight ratio of about 1:5 to about 5:1. Further preferred antifoam agents are Silicone SRE grades and Silicone SE 47M, SE39, SE2, SE9 and SE10 available from Wacker Chemie; BF20+, DB310, DC1410, DC1430, 22210, HV495 and Q2-1607 ex Dow Corning; FD20P and BC2600 supplied by Basildon; and SAG 730 ex Momentive. Other suitable antifoams, described in the literature such as in Hand Book of Food Additives, ISBN 0-566-07592-X, p. 804, are selected from dimethicone, poloxamer, polypropyleneglycol, tallow derivatives, and mixtures thereof.

Preferred among the antifoam agents described above are the silicone antifoams agents, in particular the combinations of polyorganosiloxane with silica particles.

The composition may comprise an antifreeze agent. The antifreeze agent as described below is used to improve freeze recovery of the composition.

The antifreeze active may be an alkoxylated nonionic surfactant having an average alkoxylation value of from 4 to 22, preferably from 5 to 20 and most preferably from 6 to 20. The alkoxylated nonionic surfactant may have a C log P of from 3 to 6, preferably from 3.5 to 5.5. Mixtures of such nonionic surfactants may be used.

Suitable nonionic surfactants which can be used as the antifreeze agent include in particular the reaction products of compounds having a hydrophobic group and a reactive hydrogen atom, for example aliphatic alcohols, acids, or alkyl phenols with alkylene oxides, preferably ethylene oxide either alone or with propylene oxide.

Suitable antifreeze agents may also be selected from alcohols, diols and esters. A particularly preferred additional antifreeze agent is monopropylene glycol (MPG). Other nonionic antifreeze materials, which are outside the scope of the non-ionic antifreeze component of the present invention but which may be additionally included in the compositions of the invention include alkyl polyglycosides, ethoxylated castor oils, and sorbitan esters.

Further suitable antifreeze agents are those disclosed in EP 0018039 including paraffins, long chain alcohols and several esters for example glycerol mono stearate, iso butyl stearate and iso propyl palmitate. Also materials disclosed in U.S. Pat. No. 6,063,754 such as C₁₀₋₁₂ isoparaffins, isopropyl myristate and dioctyladapate.

The composition may comprise one or more viscosity control agents, such as polymeric viscosity control agents. Suitable polymeric viscosity control agents include nonionic and cationic polymers, such as hydrophobically modified cellulose ethers (e.g. Natrosol Plus, ex Hercules), cationically modified starches (e.g. Softgel BDA and Softgel BD, both ex Avebe). A particularly preferred viscosity control agent is a copolymer of methacrylate and cationic acrylamide available under the tradename Flosoft 200 (ex SNF Floerger).

The composition may comprise a stabilizer. The stabilizer may be a mixture of a water-insoluble, cationic material and a nonionic material selected from hydrocarbons, fatty acids, fatty esters and fatty alcohols.

The composition may comprise a floc prevention agent, which may be a nonionic alkoxylated material having an HLB value of from 8 to 18, preferably from 11 to 16, more preferably from 12 to 16 and most preferably 16. The nonionic alkoxylated material can be linear or branched, preferably linear. Suitable floc prevention agents include nonionic surfactants. Suitable nonionic surfactants include addition products of ethylene oxide and/or propylene oxide with fatty alcohols, fatty acids and fatty amines. The floc prevention agent is preferably selected from addition products of (a) an alkoxide selected from ethylene oxide, propylene oxide and mixtures thereof with (b) a fatty material selected from fatty alcohols, fatty acids and fatty amines.

The composition may comprise a polymeric thickening agent. Suitable polymeric thickening agents are water soluble or dispersable. Monomers of the polymeric thickening agent may be nonionic, anionic or cationic. Following is a non-restrictive list of monomers performing a nonionic function: acrylamide, methacrylamide, N-Alkyl acrylamide, N-vinyl pyrrolidone, N-vinyl formamide, N-vinyl acetamide, vinylacetate, vinyl alcohol, acrylate esters, allyl alcohol. Following is a non-restrictive list of monomers performing an anionic function: acrylic acid, methacrylic acid, itaconic acid, crotonic acid, maleic acid, fumaric acid, as well as monomers performing a sulfonic acid or phosphonic acid functions, such as 2-acrylamido-2-methyl propane sulfonic acid (ATBS) etc. The monomers may also contain hydrophobic groups. Suitable cationic monomers are selected from the group consisting of the following monomers and derivatives and their quaternary or acid salts: dimethylaminopropylmethacrylamide, dimethylaminopropylacrylamide, diallylamine, methyldiallylamine, dialkylaminoalkyl-acrylates and methacrylates, dialkylaminoalkyl-acrylamides or -methacrylamides.

Polymeric thickening agents particularly useful in the composition of the invention include those described in WO2010/078959. These are crosslinked water swellable cationic copolymers having at least one cationic monomer and optionally other nonionic and/or anionic monomers. Preferred polymers of this type are copolymers of acrylamide and trimethylaminoethylacrylate chloride.

Preferred polymers comprise less than 25 percent of water soluble polymers by weight of the total polymer, preferably less than 20 percent, and most preferably less than 15 percent, and a cross-linking agent concentration of from 500 ppm to 5000 ppm relative to the polymer, preferably from 750 ppm to 5000 ppm, more preferably from 1000 to 4500 ppm (as determined by a suitable metering method such as that described on page 8 of patent EP 343840). The cross-linking agent concentration must be higher than about 500 ppm relative to the polymer, and preferably higher than about 750 ppm when the crosslinking agent used is the methylene bisacrylamide, or other cross-linking agents at concentrations that lead to equivalent cross-linking levels of from 10 to 10,000 ppm.

The composition of the present invention may be prepared by any mixing means known by a person skilled in the art. Preferably, the composition is prepared by mixing the polymer dispersion with other ingredients, including but not limited to, the quaternary ammonium compounds, the polysaccharide, the fragrance and perfume, and other additives as described above.

Preferably, the pH value of the composition is adjusted to be in the range of 2.5 to 8, by using a suitable acidic agent or basic agent. Optional additives may also be added to the composition at this stage.

The composition of the present invention may take a variety of physical forms including liquid, liquid-gel, paste-like, foam in either aqueous or non-aqueous form, and any other suitable form known by a person skilled in the art. For better dispersibility, a preferred form of the composition is a liquid form, and in the form of an aqueous dispersion in water. When in a liquid form, the composition may also be dispensed with dispensing means such as a sprayer or aerosol dispenser.

III. The Method of Conditioning a Fabric

In one aspect, the present invention provides a method for conditioning a fabric comprising the step of contacting an aqueous medium containing the composition of the present invention with the fabric.

The composition of the present invention can be used in a so-called rinse process. Typically the fabric conditioning composition of the present invention is added during the rinse cycle of an automatic laundry machine (such as an automatic fabric washing machine). One aspect of the invention provides dosing the composition of the present invention during the rinse cycle of the automatic laundry washing machine. Another aspect of the invention provides for a kit comprising the composition of the present invention and optionally instructions for use.

When being used in the rinse process, the composition is first diluted in an aqueous rinse bath solution. Subsequently, the laundered fabrics which have been washed with a detergent liquor and optionally rinsed in a first inefficient rinse step (“inefficient” in the sense that residual detergent and/or soil may be carried over with the fabrics), are placed in the rinse solution with the diluted composition. Of course, the composition may also be incorporated into the aqueous bath once the fabrics have been immersed therein. Following that step, agitation is applied to the fabrics in the rinse bath solution causing the suds to collapse, and residual soils and surfactant is to be removed. The fabrics can then be optionally wrung before drying.

Accordingly, in still another aspect, there is provided a method for rinsing fabrics, which comprises the steps of contacting the fabrics, preferably previously washed in a detergent liquor, with the composition according to the present invention. The subject-matter of the invention also includes the use of the composition of the present invention to impart fabric softness to fabrics; notably for fabrics that have been washed in a high suds detergent solution, while providing in the rinse a reduction of suds or foaming and without the creation of undesirable flocs.

In still another aspect, the present invention also concerns a method for conditioning a fabric comprising contacting an aqueous medium comprising the composition of the present invention with the fabric during a rinse cycle of a fabric washing machine.

This rinse process may be performed manually in basin or bucket, in a non-automated washing machine, or in an automated washing machine. When hand washing is performed, the laundered fabrics are removed from the detergent liquor and wrung out. The composition of the present invention may be then added to fresh water and the fabrics are then, directly or after an optional inefficient first rinse step, rinsed in the water containing the composition according to the conventional rinsing habit. The fabrics are then dried using conventional means.

In still another aspect, the present invention also concerns the use of the above polymer dispersion in conditioning fabrics.

Should the disclosure of any patents, patent applications, and publications which are incorporated herein by reference conflict with the description of the present application to the extent that it may render a term unclear, the present description shall take precedence.

The following examples are included to illustrate embodiments of the invention. Needless to say, the invention is not limited to the described examples.

### EXAMPLES

1. Materials

The materials used in the examples are illustrated as below:

| N | Component | Description | Producer |
|---|---|---|---|
| 1 | Fentacare TEP-88 | Quaternary | Solvay |
| | | ammonium salt | |
| 2 | RC5068 | Liquid perfume | International |
| | | | Flavors and |
| | | | Fragrances |
| 3 | Dose of Zing | Encapsulated | International |
| | | perfume | Flavorsand |
| | | | Fragrance |
| 4 | Proxel GXL | Preservative | Arch Biocides |
| 5 | Liquitint Blue MC | Dye | Milliken |
| | | | Chemicals |
| 6 | Liquitint Violet LC | Dye | Milliken |
| | | | Chemicals |
| 7 | Acrylamidopropyltrimethyla | Cationic monomer | TCI chemicals |
| | mmonium chloride (APTAC) | | |
| 8 | Rhodixan A1 | Transfer agent | Solvay |
| 9 | V50 | Initiator | WAko |
| 10 | Triquat | Cationic monomer | |
| 11 | EL-81 | Silicone oil | Bluestar |
| 12 | Guar | Cationic guar and | |
| | | non-ionic guar (1:3 in | |
| | | weight ratio) | |

2. The Preparation of the Polymer Dispersion

2.1 Preparation of the Prepolymer p(0)

In a 2 L double jacketed reactor, equipped with a condenser, a mechanical stirrer, a thermal probe and a nitrogen inlet, one introduced 99.20 g of deionized water, 66.65 g of ethanol, 16.66 g of Rhodixan A1, 11.78 g of acrylamide (AM, hereinafter, 50 wt % in water) and 2.81 g of APTAC (75 wt % in water). The pH of mixture was adjusted to 3 with sulfuric acid (10%) and the mixture was deoxygenated by nitrogen bubbling for 30 minutes. Then the mixture was heated to 60° C. in 30 minutes. When the temperature into the reactor reached 60° C., 2.17 g of an aqueous solution of V50 at 5 wt % was added shotwise. Then 781.19 g of an aqueous solution of acrylamide (577.18 g, 50 wt % in water) and APTAC (137.88 g, 75 wt % in water) was added for 240 minutes, and 19.53 g of an aqueous solution of V50 at 5 wt % was added for 360 minutes. After the end of the introduction of V50, the mixture was maintained at 60° C. for 2 hours. Then the mixture was cooled down to room temperature. The poly(acrylamide-co-APTAC)-Xa (“the prepolymer p(0)”) was obtained at the end of the reaction.

2.2 The Preparation of the Polymer Dispersion of Examples 1 to 3

### Comparative Example 1

In a 0.5 L double jacketed reactor, equipped with a condenser, a mechanical stirrer, a thermal probe and a nitrogen inlet, one introduced 70.7 g of an aqueous solution of the prepolymer p(0) at 25 wt %. The pH is then adjusted to 8 with NaOH 50 wt %. The solution was heated up to 75° C. When the temperature reached 75° C., 3.263 g of an aqueous solution of H₂O₂ (30 wt % in water) was introduced into the reactor for 60 minutes. The solution was kept at 75° C. for 4 hours after the end of the addition of H₂O₂ and then cooled down to room temperature.

### Example 1

In a 0.5 L double jacketed reactor, equipped with a condenser, a mechanical stirrer, a thermal probe and a nitrogen inlet, one introduced 191.9 g of deionized water and 42.0 g of an aqueous solution of the prepolymer p(0) at 40 wt %. The mixture was deoxygenated by nitrogen bubbling for 30 minutes. Then 15.4 g of vinyl acetate (VAC hereinafter) were introduced into the reactor and the mixture was heated to 67° C. in one hour. When the temperature into the reactor reached 67° C., 0.5734 g of an aqueous solution of sodium persulfate was introduced into the reactor. After one hour of reaction, 92.167 mL of vinyl acetate was added for 180 minutes, and 4.86 mL of an aqueous solution of sodium persulfate at 10 wt % was added for 210 minutes. After the end of the introduction of sodium persulfate, the mixture was heated up to 75° C. At 75° C., 0.296 of an aqueous solution of tert-butyl hydroperoxide (70 wt %) was introduced into the reactor, followed 15 minutes later by the introduction in two hours of an aqueous solution of ascorbic acid (4.05 at 5 wt %). The mixture was then cooled down to room temperature to provide the polymer dispersion.

### Example 2

In a 2 L double jacketed reactor, equipped with a condenser, a mechanical stirrer, a thermal probe and a nitrogen inlet, one introduced 686 g of deionized water, 91 g of ethanol, 199.02 g of an aqueous solution of the prepolymer p(0) at 40 wt %, 1.72 g of an aqueous solution of sodium persulfate (10 wt % in water) and 61.03 g of butyl acrylate (BA hereinafter). The mixture was deoxygenated by nitrogen bubbling for 30 minutes. Then the mixture was heated to 80° C. When the temperature into the reactor reached 80° C., 345.86 g butyl acrylate was added for 240 minutes, and 15.51 g of an aqueous solution of sodium persulfate at 10 wt % was added for 330 minutes. After the end of the introduction of sodium persulfate, the mixture was maintained at 80° C. for 2 hours and then cooled down to room temperature to provide the polymer dispersion.

### Example 3

In a 0.5 L double jacketed reactor, equipped with a condenser, a mechanical stirrer, a thermal probe and a nitrogen inlet, one introduced 108.22 g of deionized water, 108.22 g of ethanol, 62.10 g of an aqueous solution of the prepolymer p(0) at 37 wt %, 0.34 g of an aqueous solution of sodium persulfate (10 wt % in water) and 17.71 g of 2-ethyl hexyl acrylate (2-EHA hereinafter). The mixture was deoxygenated by nitrogen bubbling for 30 minutes. Then the mixture was heated to 80° C. When the temperature into the reactor reached 80° C., 100.35 g of 2EHA was added for 240 minutes, and 3.06 g of an aqueous solution of sodium persulfate at 10 wt % was added for 330 minutes. After the end of the introduction of sodium persulfate, the mixture was maintained at 80° C. for 2 hours and then cooled down to room temperature to provide the polymer dispersion.

The other polymer dispersions used in the present invention are prepared by the same procedures as above.

3. Preparation of the Fabric Conditioning Composition with Polymer Dispersion

The fabric conditioning compositions of the present invention are prepared by the same procedures as below:
1. An aqueous solution with concentration of 0.5 wt. % was prepared. The active content of the polymer dispersion were taken into consideration in the preparation (% solid from polymerization in the latex).
2. The solution was stirred at room temperature using a magnetic stir bar for 15 minutes.
3. The solution were diluted down to 0.004 wt % for the fabric treatment ( ).

4. Fabric Treatment

The fabrics were treated in a two-part procedure: (A) Treatment with solution of conditioning agent; (B) Drying and conditioning. The steps of each part of the procedure are described as below:

(A) Treatment with Solution of Conditioning Formulation.
1) 3 pieces of fabric with approximate weight of 40 grams are put into the vessel of a tergotometer. If the weight of the fabrics does not add up to 40 g an additional small piece is added in order for the total weight of the fabrics to be 40 g. This additional piece is not used in the softness evaluation;
2) The volume of the solution is 1000 ml;
3) The fabrics were soaked for 10 minutes at speed of rotation of the tergotometer of 75 rpm at temperature of 25±1° C.

(B) Drying and Conditioning.
1) The fabrics are spin-dried for 10 minutes at 720 rpm in spin-dryer (Samsung Washing Machine, Model No: WA90F5S9);
2) The fabrics are hanged on a clothes rack in a special room (humidity: 61±2%; temperature: 20±2° C.) for 48 hours. The fabrics are well-separated (at least one bar distance) from each other in order to avoid contamination.

5. Softness Assessment

The softness was assessed in a panel of 6 people. The panel lists assign a number from 1 to 5 characterizing the softness, higher score corresponds to better softness.

The majority of the panels included 4 samples:

(1) Negative Benchmark (NBM)

As a negative benchmark we used fabrics which were subjected to the same treatment as the studied fabrics, but with pure water (no polymer dispersion added).

(2) Positive Benchmark (PBM)

A fabric treatment composition was used as a positive benchmark (PBM), containing the commercially available Fentacare® TEP-88 of formula:

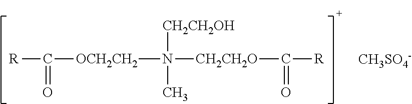

at the same weight concentration as in the compositions according to the invention (namely 0.004%).

(3) Softness Determination

For each system (NBM, PBM, samples with unknown softness) 6 fabrics were prepare. Each fabric is touched only 3 times. The number of touches has to be limited as touching the fabric can lead to increase in softness. A total of 18 determinations of the softness is for each system. The softness is calculated as an average of the 18 values. The standard deviation of the measurement is calculated in the following manner:

$$S {D}_{P} = \sqrt{\frac{( {n}_{1} - 1 ) S {D}_{1}^{2} + ( {n}_{2} - 1 ) S {D}_{2}^{2} + … + ( {n}_{k} - 1 ) S {D}_{k}^{2}}{{n}_{1} + {n}_{2} + … + {n}_{k} - k}}$$

Here SD_{P} is the so-called pooled standard deviation; SD₁, SD₂, SD_{K} are the standard deviations for each group; n₁, n₂, nₖ are the number of fabrics in each group. In our case we have 3 groups each containing the same number of fabrics (6). SD₁, SD₂ and SD₃ are the standard deviations of the determination of the score from the 1^{st}, 2^{nd} and 3^{rd} touch, respectively. The above equation can be written as follows:

$$S {D}_{P} = \sqrt{\frac{S {D}_{1}^{2} + S {D}_{2}^{2} + S {D}_{3}^{2}}{3}}$$

The standard error for each system is calculated via the following equation:

$$S {E}_{P} = \frac{S {D}_{P}}{\sqrt{N}}$$

Here N=18 is the total number of the measurements (or touches in our case).

The softness score assigned to a studied sample is not an absolute value, and makes sense only when compared to the values of the positive and negative benchmark in the same panels. A correct comparison would reflect the degree in which the compared samples differ from the PBM and the NBM. In order to be able to compare systems studied in different panels, softness degree (SDG) is introduced:

$$S D G = \frac{Score ( studied system ) - Score ( NBM )}{Score ( PBM ) - Score ( NBM )} \times 100$$

The SDG is measured in percent. The NBM and PBM have 0% and 100% SDG, respectively. The majority of the studied systems have SDG in the range 0 to 100%, some exceptionally well performing systems have SDG over 100%.

The standard error of the softness degree is calculated via the standard rules for error propagation:

Δ(a±b)=\sqrt{Δa²+Δb²} (5a)

Δ(a/b)=(a/b)\sqrt{(Δa/a)²+(Δb/b)²} (5b)

6. Fragrance Sensory Evaluation

Fragrance Sensory Evaluation was implemented according to ASTM D5237-14 standard guide for evaluating fabric conditioner. The fragrance/solvent intensity of neat samples/dry fabrics was evaluated by 10 panelists.

For dry towels fragrance evaluation, the fragrance of each treated towel was evaluated by 10 panelists independently in which the panelist rate the fragrance on its intensity only. The fragrance intensity of the treated towels was rated in a scale of 1 to 10, wherein 1 represents the lowest intensity and 10 represents the strongest intensity. The average fragrance rating of the towels was calculated.

7. Softness Assessments Results for the Fabric Conditioning Composition Prepared by Different Monomer (m)

As shown in the table 2, the comparative example 1 prepared without monomer (m) doesn't show obvious fabric conditioning performance, the examples 1 to 3 prepared by different monomers (m) all show remarkable conditioning performance, the examples 4 prepared by different monomer (Ac) also shows remarkable conditioning.

TABLE 1
the fabric conditioning composition prepared
by different (or without) monomer (m)

| | | | Mole | | | |
|---|---|---|---|---|---|---|
| | Monomer | Monomer | ratio | | Softness | SEp, |
| | (m) | An/Ac | An/Ac | R_{HH} | degree | % |
| Comparative | / | AM/APTAC | 9:1 | / | 17 | 11 |
| example 1 | | | | | | |
| Example 1 | VAC | AM/APTAC | 9:1 | 20 | 26 | 11 |
| Example 2 | BA | AM/APTAC | 9:1 | 20 | 94 | 3 |
| Example 3 | 2-EHA | AM/APTAC | 9:1 | 20 | 88 | 7 |
| Example 4 | BA | AM/Triquat | 9:1 | 20 | 65 | 5 |

8. Softness Assessments Results of the Fabric Conditioning Compositions Prepared by Different Mole Ratio of An/Ac

As shown in the table 3, examples 5 to 7 all show remarkable fabric conditioning performance, however when the mole ratio of monomer An/Ac is between 9:1 to 4:1, better performance is achieved.

TABLE 2
the fabric conditioning composition prepared
by different mole ratio An/Ac

| | | | Mole | | | |
|---|---|---|---|---|---|---|
| | Monomer | Monomer | ratio | | Softness | SEp, |
| | (m) | An/Ac | An/Ac | R_{HH} | degree | % |
| Example 5 | BA | AM/APTAC | 19:1 | 20 | 56 | 7 |
| Example 6* | BA | AM/APTAC | 9:1 | 20 | 97 | 3 |
| Example 7 | BA | AM/APTAC | 4:1 | 20 | 85 | 5 |

*the same as example 2

9. Softness Assessments Results the Fabric Conditioning Composition Prepared by Different R_{HH}

As shown in the table 4, examples 8 to 10 all show remarkable fabric conditioning performance, however when the R_{HH} is between 1:3.3 to 1:5, better performance is achieved.

TABLE 3
the fabric conditioning composition prepared by different R_{HH}

| | | | Mole | | | |
|---|---|---|---|---|---|---|
| | Monomer | Monomer | ratio | | Softness | SEp, |
| | (m) | An/Ac | An/Ac | R_{HH}, | degree | % |
| Example 8 | BA | AM/APTAC | 9:1 | 1:40 | 61 | 11 |
| Example 9* | BA | AM/APTAC | 9:1 | 1:5 | 97 | 3 |
| Example 10 | BA | AM/APTAC | 9:1 | 1:3.3 | 87 | 5 |

*the same as example 2 or 6

10. The Fabric Conditioning Composition Comprising Quaternary Ammonium and the Polymer Dispersion

The fabric conditioning composition comprising quaternary ammonium and the polymer dispersion was prepared as below:
(1) The TEP was heated and melted.
(2) Water was heated upon stirring at 250 rpm.
(3) Minors are added: preservative (Proxel GXL).
(4) The solution was mixed for 2 minutes.
(5) The melted TEP was added to the solution while stirring at speed 300-350 rpm.
(6) Polymer dispersion was added.
(7) Dyes were added (Liquitint Blue MC; Liquitint Violet LC).
(8) The mixture was stirred for 10 minutes at speed 300-350 rpm.
(9) The encaps pre-dilution was added.
(10) The solution was stirred for 3 minutes.
(11) The solution was cooled down to 35° C.
(12) The liquid perfume oil was added.
(13) The solution was stirred for 5 minutes.
(14) The formulation was placed in a plastic bottle.

The fabric conditioning composition comprising quaternary ammonium, the polymer dispersion and Guar was prepared the same as above, where the premixed guar powders are added to water between the step (2) and (3).

The polymer dispersion 1 is the same as used in the example 9.

Examples 12 and 13 are the fabric conditioning composition comprising quaternary ammonium and the polymer dispersion also shows remarkable fabric conditioning performance, and the performance are even better when guar is added.

In addition, by the comparison of example 12 and comparative example 2, and example 13 and comparative example 3, the polymer dispersion is parity for the fabric conditioning performance, thus can replace silicone oil in the composition.

TABLE 4
the fabric conditioning composition comprising TEP and/or Guar

| | quaternary | polymer | | Silicone | Softness | SEp, |
|---|---|---|---|---|---|---|
| | ammonium | dispersion | polysaccharide | oil | degree | % |
| Example 12 | TEP, 6 | polymer | / | / | 73 | 6 |
| | wt. % | dispersion | | | | |
| | | 1, 0.5 wt. % | | | | |
| Example 13 | TEP, 6 | polymer | Guar | / | 95 | 6 |
| | wt. % | dispersion | | | | |
| | | 1, 0.5 wt. % | | | | |
| Comparative | TEP, 6 | / | / | 0.5 wt. % | 82 | 6 |
| example 2 | wt. % | | | EL-81 | | |
| Comparative | TEP, 6 | / | Guar | 0.5 wt. % | 97 | 6 |
| example 3 | wt. % | | | EL-81 | | |

As shown in table 6, the fragrance performance was evaluated. Compared to the comparative example 4, example 14 shows better fragrance performance, particularly encapsulated perfume performance

TABLE 5
the fabric conditioning composition comprising TEP and/or Guar

| | | | | | Encapsulated |
|---|---|---|---|---|---|
| | | | | Perfume Oil | Perfume |
| | quaternary | polymer | | Evaluation | Evaluation |
| | ammonium | dispersion | polysaccharide | Score | Score |
| Example 14 | TEP, 6 | polymer | Guar | 3.9 | 6.9 |
| | wt. % | dispersion | | | |
| | | 1, 1 wt. % | | | |
| Comparative | TEP, 6 | / | Guar | 4.1 | 5.5 |
| example 4 | wt. % | | | | |

1. A polymer dispersion prepared by a step (E) of radical polymerization in an aqueous medium (M) in the presence of:
at least a pre-polymer (p0) soluble in the aqueous medium (M) of formula (I):
(R¹¹)X-Z¹¹—C(═S)—Z¹²-[A]-R¹² (I)
wherein:
Z¹¹ represents C, N, O, S or P,
Z¹² represents S or P,
R¹¹ and R¹², which may be identical or different, represent:
an optionally substituted alkyl, acyl, aryl, alkene or alkyne group (i), or
a saturated or unsaturated, optionally substituted or aromatic carbon-based ring (ii), or
a saturated or unsaturated, optionally substituted heterocycle (iii), these groups and rings (i), (ii) and (iii) possibly being substituted with substituted phenyl groups, substituted aromatic groups or groups: alkoxycarbonyl or aryloxycarbonyl (—COOR), carboxyl (—COOH), acyloxy (—O₂CR), carbamoyl (—CONR), cyano (—CN), alkylcarbonyl, alkylarylcarbonyl, arylcarbonyl, arylalkylcarbonyl, phthalimido, maleimido, succinimido, amidino, guanidimo, hydroxyl (—OH), amino (—NR), halogen, allyl, epoxy, alkoxy (—OR), S-alkyl, S-aryl, groups of hydrophilic or ionic nature such as the alkali metal salts of carboxylic acids, the alkali metal salts of sulphonic acid, polyalkylene oxide (PEO or PPO) chains and cationic substituents (quaternary ammonium salts), R representing an alkyl or aryl group;
x corresponds to the valency of Z¹¹, or alternatively x is 0, in which case Z¹¹ represents a phenyl, alkene or alkyne radical, optionally substituted with an optionally substituted alkyl; acyl; aryl; alkene or alkyne group; an optionally substituted, saturated, unsaturated, or aromatic, carbon-based ring; an optionally substituted, saturated or unsaturated heterocycle; alkoxycarbonyl or aryloxycarbonyl (—COOR); carboxyl (—COOH); acyloxy (—O2CR); carbamoyl (—CONR); cyano (—CN); alkylcarbonyl; alkylarylcarbonyl; arylcarbonyl; arylalkylcarbonyl; phthalimido; maleimido; succinimido; amidino; guanidimo; hydroxyl (—OH); amino (—NR); halogen; allyl; epoxy; alkoxy (—OR), S-alkyl; S-aryl groups; groups of hydrophilic or ionic nature; and
[A] represents a polymer chain derived from monomers comprising cationic monomers [Ac] and non-ionic monomers [An];
at least one free-radical polymerization initiator, and
at least one ethylenically unsaturated hydrophobic monomer (m) which is the one or more selected from the group consisting of C1-C10 alkyl (meth)acrylate, vinyl esters of a carboxylic acid, and vinyl nitrile; wherein the aqueous medium (M) includes water and at least one water miscible solvent.

2. The polymer dispersion according to claim 1, wherein the cationic monomer [Ac] is selected from quaternary ammonium monomer bearing at least one carbon-carbon double bonds.

3. The polymer dispersion according to claim 2, wherein the quaternary ammonium monomer bearing at least one carbon-carbon double bonds is the one or more selected from the group consisting of:
Trimethylammoniumpropylmethacrylamide salts;
(3-methacrylamidopropyl)trimethylammonium salts;
(3-acrylamidopropyl)trimethylammonium salts;
ethacryloyloxyethyltrimethylammonium salts;
acryloyloxyethyltrimethylammonium salts;
methyldiethylammoniumethyl acrylate salts;
benzyldimethylammoniumethyle acrylate salts;
1-ethyl 2-vinylpyridinium salts;
1-ethyl 4-vinylpyridinium salts;
N-dimethyldiallylammonium salts;
N¹-(3-(2-((3-methacrylamidopropyl)dimethylammonio)acetamido) propyl)-N¹, N¹, N³, N³, N³-pentamethylpropane-1,3-diaminium salts;
2-hydroxy-N 1-(3-methacrylamidopropyl)-N¹, N¹, N³, N³, N³-pentamethylpropane-1,3-diaminium salts; and
the monomer of formula of 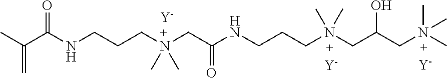
where Y is an anion.

4. The polymer dispersion according to claim 3, wherein the cationic monomer [Ac] is the one or more selected from (3-acrylamidopropyl)trimethylammonium salts, N¹-(3-(2-((3-methacrylamidopropyl)dimethylammonio)acetamido)propyl)-N¹, N¹, N³, N³, N³-pentamethylpropane-1,3-diaminium salts, or 2-hydroxy-N 1-(3-methacrylamidopropyl)-N¹, N¹, N³, N³, N³-pentamethylpropane-1,3-diaminium salts.

5. The polymer dispersion according to claim 1, wherein the non-ionic monomer [An] is the one or more selected from the group consisting of (meth)acrylamide, N-methyl(meth)acrylamide, N-ethyl(meth)acrylamide, N-propyl(meth)acrylamide, N,N-dimethyl(meth) acrylamide, N,N-diethylacrylamide, N-vinylformamide, N-vinyl-N-methyl formamide, N-vinylacetamide, N-vinyl-N-methylacetamide, N-vinyl-N-ethylacetamide, N-vinyipropionamide, N-vinyl-N-methylpropionamide, N-vinylbutyramide, N-vinylpyrrolidone, N-vinylpiperidone, and N-vinyl caprolactame, hydroxyethyl (meth)acrylate, hydroxypropyl (meth)acrylate, hydroxymethyl(meth)acrylamide, hydroxyethyl(meth)acrylamide, glycerol (meth)acrylate, N-Tris(hydroxymethyl)methyl]acrylamide, N-isporpylacrylamide.

6. The polymer dispersion according to claim 5, wherein the non-ionic monomer [An] is the one or more selected from the group consisting of (meth)acrylamide.

7. The polymer dispersion according to claim 1, wherein the mole ratio of the non-ionic monomers [An] to the cationic monomers [Ac] is in the range 15:1 to 2:1.

8. The polymer dispersion according to claim 1, wherein the ethylenically unsaturated monomer (m) is the one or more selected from the consisting of methyl acrylate, ethyl (meth)acrylate, propyl (meth)acrylate, butyl (meth)acrylate, pentyl (meth)acrylate, hexyl (meth)acrylate, 2-ethylhexyl acrylate, vinyl acetate, vinyl versatate or vinyl propionate, and vinyl nitrile.

9. The polymer dispersion according to claim 1, wherein the pre-polymer (pO) has a weigh average molecular weight of 2500 to 20000.

10. The polymer dispersion according to claim 1, wherein weight ratio of the pre-polymer (pO) to the ethylenically unsaturated monomer (m) is in the range of 1:3 to 1:15.

11. A fabric conditioning composition, comprising a polymer dispersion prepared according to claim 1.

12. The fabric conditioning composition according to claim 11, wherein the fabric conditioning composition further comprises one or more ester quaternary ammonium salts.

13. The fabric conditioning composition according to claim 12, wherein the ester quaternary ammonium salt is the one or more selected from the group consisting of:
TET: Di(tallowcarboxyethyl)hydroxyethyl methyl ammonium methylsulfate,
TEO Di(oleocarboxyethyl)hydroxyethyl methyl ammonium methylsulfate,
TES: Distearyl hydroxyethyl methyl ammonium methylsulfate,
TEHT Di(hydrogenated tallow-carboxyethyl)hydroxyethyl methyl ammonium methylsulfate,
TEP Di(palmiticcarboxyethyl)hydroxyethyl methyl ammonium methylsulfate, and
DEEDMAC: Dimethylbis[2-[(1-oxooctadecyl)oxy]ethyl]ammonium chloride.

14. The fabric conditioning composition according to claim 12, wherein the ester quaternary ammonium salts has an amount of 5.5 to 15 wt. %, based on the total weight of the fabric conditioning composition.

15. The fabric conditioning composition according to claim 11, wherein the fabric conditioning composition further comprises a polysaccharide which is the one or more selected from cationic polysaccharide and non-ionic polysaccharide.

16. The fabric conditioning composition according to claim 15, wherein the polysaccharide is a mixture of cationic polysaccharide and non-ionic polysaccharide.

17. The fabric conditioning composition according to claim 11, wherein the solid content of the polymer dispersion has an amount of 0.0001 to 20 wt. %, based on the total weight of the fabric conditioning composition.

18. (canceled)

19. A method of conditioning a fabric, comprising the steps of:
contacting the fabric with an aqueous medium comprising the fabric conditioning composition according to claim 11.
